(19) United States
(12) Patent Application Publication
(10) Pub. No.: US 2004/0250082 A1
(43) Pub. Date: Dec. 9, 2004

(54) Digital signature generation method, digital signature authentication method, digital signature generation request program and digital signature authentication request program

(75) Inventors: Tao Li, Kawasaki (JP); Junichi Koizumi, Kawasaki (JP); Hiroki Katoh, Kawasaki (JP); Tatsuhiro Miyazaki, Yokohama (JP)

Correspondence Address: Patrick G. Burns, Esq., GREER, BURNS & CRAIN, LTD., Suite 2500, 300 South Wacker Drive, Chicago, IL, 60606, US

(73) Assignee: FUJITSU LIMITED

(21) Appl. No.: 10/811,323

(22) Filed: Mar. 26, 2004

(30) Foreign Application Priority Data
Mar. 28, 2003 (JP) 2003-092280

(51) Int. Cl. H04L 9/00

(52) U.S. Cl. 713/181

(57) ABSTRACT

A terminal of a user as an issuer of electronic information calculates a Digest value for a content and sends this Digest value and a key ID of the issuer user to an authentication center server device. The authentication center server device searches a key storage for a secret key corresponding to this key ID, generates a signature value by encrypting the Digest value with this secret key and responds the signature value to the user terminal. The user terminal forms an undersigned content by attaching the received signature value and key ID to signature object electronic information, and issues this content to a recipient. The terminal of the recipient user calculates a Digest value for the content in the undersigned content, and sends this Digest value, the signature value and the attachment key ID to the authentication center server device. The authentication center server device searches the key storage for a public key corresponding to the key ID, decrypts the signature value with this public key, makes authentication as to whether a result of this decryption is coincident with the Digest value or not, and responds a result of the authentication to the user terminal.

### BACKGROUND OF THE INVENTION

1. Field of the Invention

The present invention relates to a digital signature generation method for generating a digital signature for electronic information existing within any one of user terminals, a digital signature authentication method for authenticating the digital signature generated based on this digital signature generation method, a digital signature generation request program that instructs a computer communicable with the server device having a digital signature generation function to carry out the digital signature generation method, and a digital signature authentication request program that instructs the computer communicable with the server device having a digital signature authentication function to carry out the digital signature authentication method on a system configured so that a plurality user terminals and a server device can perform communications with each other via a network.

2. Description of the Prior Art

The RSA (Rivest, Shamir, Adleman) public key system has hitherto been known as an electronic information cryptography and a digital signature method as well. This RSA public key system is a system in which there is generated a pair of keys having such a relationship that electronic information encrypted by use of one key can not be decrypted unless the other key is employed, one of two keys is set as a secret key concealed from the public, and the other is set as a public key opened to the public. Then, on the occasion of giving a digital signature on electronic information, the digital signature is generated by encrypting the signature object electronic information by use of the secret key unique to an issuer of the same information, and is attached to the electronic information before being encrypted (which will hereinafter be referred to as “plain electronic information” to form undersigned electronic information), and the undersigned electronic information is transferred to its recipient party. The recipient party having received the undersigned electronic information extracts therefrom and decrypts the digital signature by use of the public key having been opened to the public by the issuer. If both of the electronic information reproduced by the decryption and the plain electronic information in the undersigned electronic information are coincident with each other as a result of collation, it can be judged that the plain electronic information is genuine. Whereas if both of them are not coincident, it can be judged that the plain electronic information is not genuine and is the one forged or falsified by a person other than the issuer.

The generation and the authentication of the digital signature as described above are conducted basically on terminals managed by the issuer and the recipient of the electronic information. There is, however, performed a service for surrogating operations of generating and authenticating the digital signature by receiving a request for generation and authentication of digital signature from those parties via a network. A server device operated by a service provider of this type of surrogation service previously registers key pairs of the individual users each establishing a contract with the service provider. The server device, upon receiving the request for generation of digital signature and the signature object electronic information from the terminal operated by any one of the users via the network, generates a digital signature by encrypting the signature object electronic information with the secret key of the user, and sends the generated digital signature back to the terminal operated by the requester user. Then, the requester user attaches the digital signature received from the server device to plain data of the signature object electronic information to form undersigned electronic information and transfers this piece of information to its recipient party. The recipient party having received this undersigned electronic information transmits the plain electronic information and the digital signature to the server device from the terminal operated by themselves via the network, and requests the server device to authenticate the digital signature. The server device having received the authentication request decrypts the digital signature with the public key registered as the one assigned to the issuer of this digital signature, and collates the electronic information reproduced by the decryption with the plain electronic information. If both of these pieces of information are coincident with each other, the server device responds to the terminal operated by the requester that the plain electronic information is genuine. Whereas if both of these pieces of information are not coincident, the server device responds to the terminal operated by the requester that the plain electronic information is not genuine.

In the conventional digital signature generation method and digital signature authentication method, however, there respectively arise the following problems whether in a case of generating or authenticating the digital signature on the terminal managed by each user or in a case of generating or authenticating the digital signature on the server device receiving the request from the issuer of the electronic information or from the recipient party.

Namely, in the case of generating and authenticating the digital signature on the terminal managed by each user, the user must keep and manage his or her own key pair, especially, the secret key so as to be neither lost nor leaked to others, and also must generate and authenticate the digital signature by himself or herself. Therefore, the user must introduce software for generating, keeping and managing the keys and generating and authenticating the digital signature in addition to hardware of the terminal. Hence, the user has to be burdened with costs for introducing and maintaining the software and hardware and costs for operating and managing them, and has to accumulate the operation know-how or to be provided with it from others.

Moreover, in the case of generating and authenticating the digital signature on the server device on the network, the user who requests the server device to generate the digital signature must send the plain electronic information to the server device via the network. Further, the user who requests the server device to authenticate the digital signature must send undersigned electronic information containing the plain electronic information and the digital signature to the server device via the network. Between the terminals operated by those users and the server device, the use of SSL (Secure Sockets Layer) of which implementation has been spread can protect the information from an unlawful access by the third party to some extent. Further, the unlawful access of the third party can also be stopped by utilizing cryptographic techniques such as a RSA public key encryption algorithm, etc. during transmission of the undersigned electronic information between the issuer and the recipient. Within the server device, however, the electronic information before being encrypted or after being decrypted is plain data, and hence the substance of the electronic information can not be concealed from the service provider who operates this server device.

### SUMMARY OF THE INVENTION

The present invention is aimed at providing a digital signature generation method and a digital signature authentication method which are capable of reducing a load on each user by surrogation for generating or authenticating a digital signature on a server device on a network, generating encryption information functioning as the digital signature without encrypting or decrypting objective electronic information itself on the server device and capable of authenticating the objective electronic information. The present invention is also aimed at providing a digital signature generation request program that instructs a computer communicable with the server device having a digital signature generation function to carry out the digital signature generation method described above, and a digital signature authentication request program that instructs the computer communicable with the server device having a digital signature authentication function to carry out the digital signature authentication method described above.

According to the digital signature generation method of the present invention contrived to obviate the problems described above, an issuer terminal operated by an issuer of signature object electronic information calculates a Digest value for the signature object electronic information, and sends this Digest value and identifying information of a user as the issuer of the signature object information to a server device. Then, the server device takes a secret key corresponding to the identifying information received from the issuer terminal, out of a storage device stored with a pair of a secret key and a public key related with identifying information of each user, generates a signature value by encrypting the Digest value received from the issuer terminal with the secret key taken out of the storage device, and responds the generated signature value to the issuer terminal. Then, the issuer terminal forms undersigned electronic information by attaching the signature value and the identifying information responded from the server device to the electronic information.

Further, according to a digital signature authentication method of the present invention contrived to obviate the aforementioned problems, a recipient terminal operated by a recipient party having received undersigned electronic information from an issuer calculates a Digest value for electronic information in the undersigned electronic information, sends the Digest value, and a signature value and the identifying information in the undersigned electronic information to the server device, takes a public key corresponding to the identifying information received from the recipient terminal, out of the storage device, decrypts the signature value received from the recipient terminal with the public key taken out of the storage device, compares a substance of the decrypted signature value with the Digest value received from the recipient terminal, and responds a result of the comparison to the recipient terminal.

According to the digital signature generation method and the digital signature authentication method of the present invention that have the aforementioned architectures, the signature value defined as a substance of the digital signature is not the signature object electronic information itself but the value generated by encrypting, within the server device, the Digest value calculated based on the signature object electronic information within the issuer terminal. Therefore, according to the present invention, a load on the user can be reduced by surrogation for generating and authenticating the digital signature on the server device in the network, and nevertheless the signature object electronic information itself does not exist in the server device either when generating the digital signature or when authenticating the digital signature. The substance of the signature object electronic information can not be therefore known by a management administrator of the server device.

Moreover, a digital signature generation request program of the present invention instructs a computer as the issuer terminal given above to, if electronic information and identifying information of a user as the issuer of the electronic information are inputted, calculate a Digest value for the electronic information, and send a digital signature generation request message containing the calculated Digest value as the encryption object information and the identifying information to the server device, and, if the signature value is responded from the server device, form undersigned electronic information by attaching the signature value and the identifying information to the electronic information.

Still further, a digital signature authentication request program of the present invention instructs a computer as the aforementioned recipient terminal to, if the undersigned electronic information is inputted, calculate a Digest value for the electronic information in the undersigned electronic information, and send a digital signature authentication request message containing the Digest value as the authentication object information and the signature value and the identifying information in the undersigned electronic information to the server device.

The invention will be described below in detail with reference to the accompanying drawings, in which:

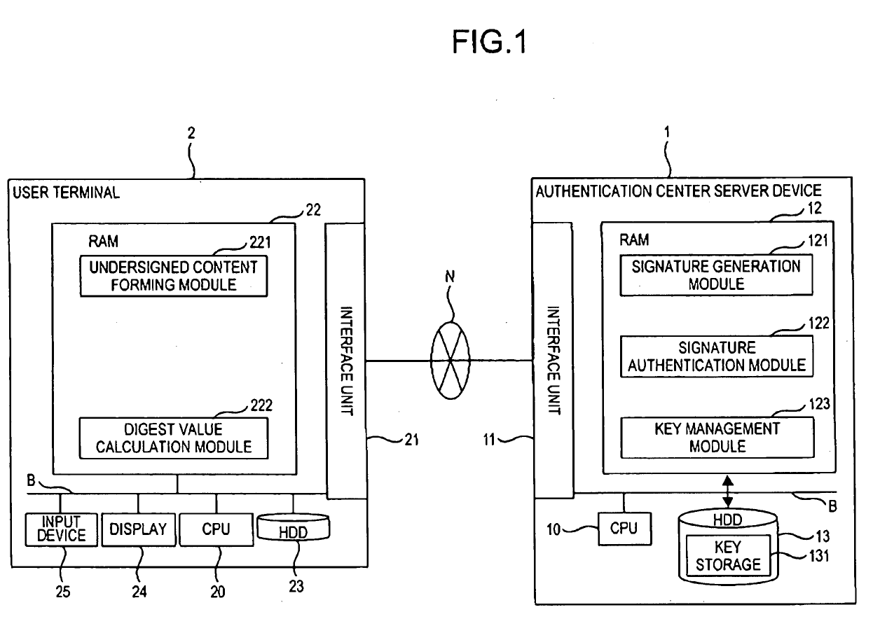

FIG. 1 is a block diagram showing a digital signature system by way of an embodiment of the present invention;

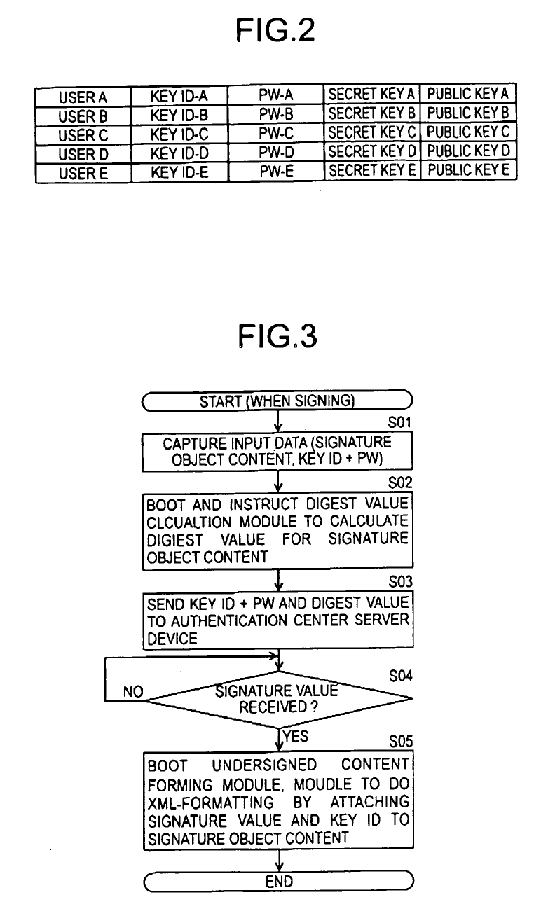

FIG. 2 is a table logically illustrating a data structure of a key storage;

FIG. 3 is a flowchart showing a processing within a user terminal on the basis of a digital signature request program when generating a digital signature;

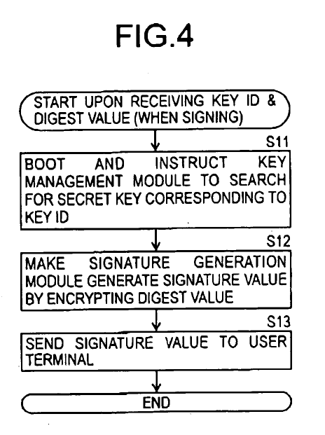

FIG. 4 is a flowchart showing a processing within an authentication center server devicc on the basis of a digital signature surrogation program when generating the digital signature;

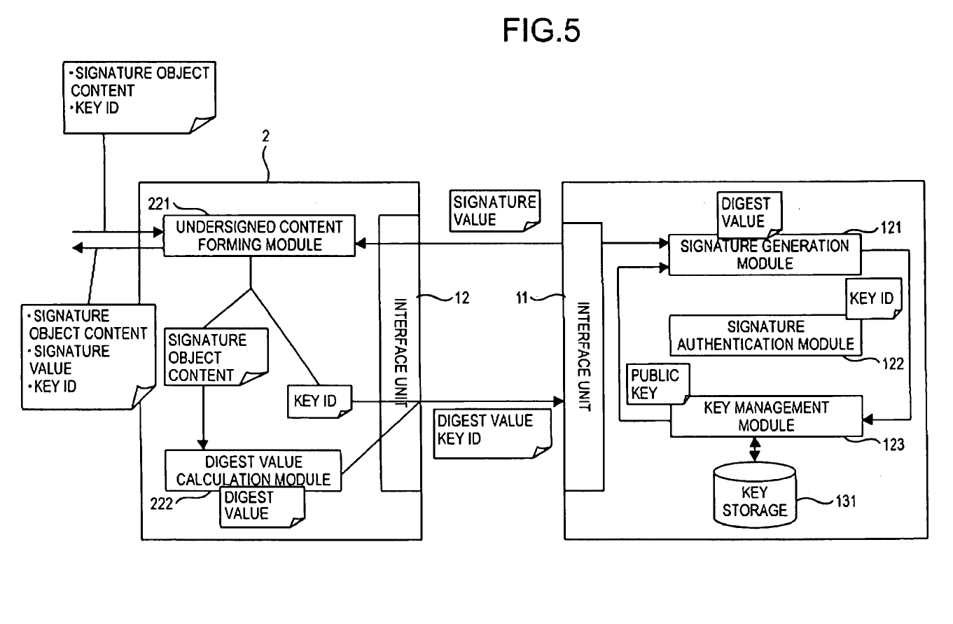

FIG. 5 is a sequence diagram showing a flow of information when generating the digital signature;

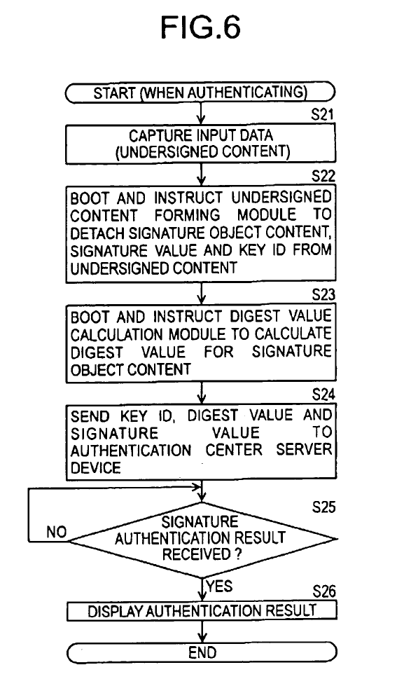

FIG. 6 is a flowchart showing a processing within the user terminal on the basis of the digital signature request program when authenticating the digital signature;

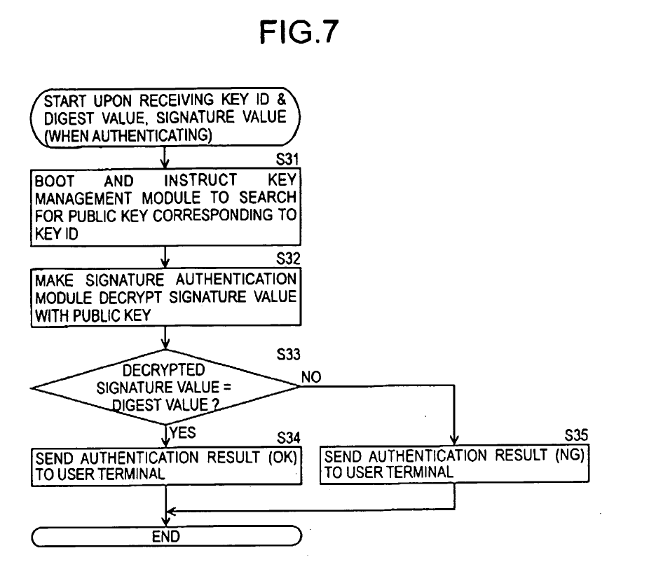

FIG. 7 is a flowchart showing a processing within the authentication center server device on the basis of the digital signature surrogation program when authenticating the digital signature; and

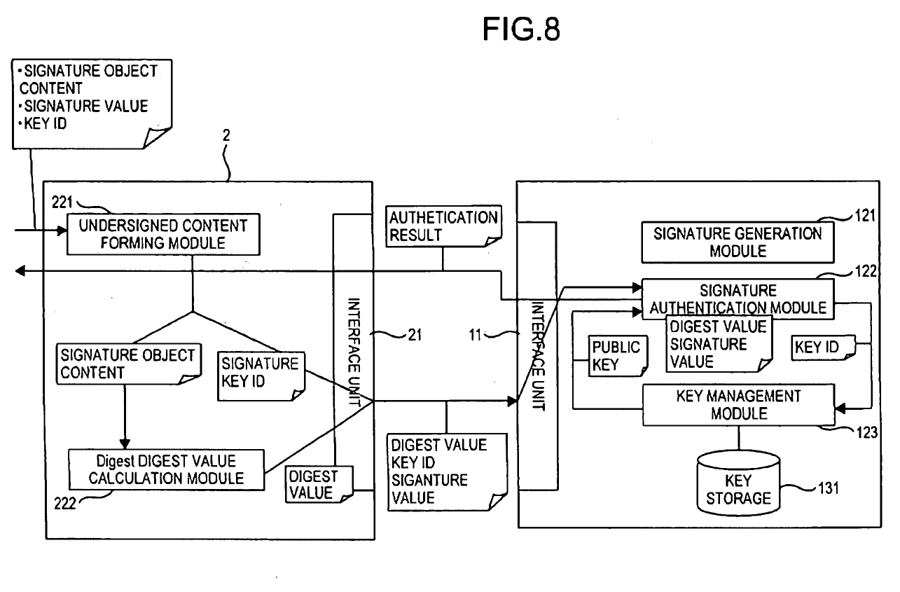

FIG. 8 is a sequence diagram showing a flow of information when authenticating the digital signature.

### DESCRIPTION OF THE PREFERRED EMBODIMENT

An embodiment of the present invention will hereinafter be discussed with reference to the drawings.

Signature object electronic information in this embodiment is an XML (Extensible Markup Language) text and will be termed a “signature object content”.

FIG. 1 is a block diagram showing an outline of architecture of a digital signature system for embodying a digital signature generation method and a digital signature authentication method according to the present invention. This digital signature system is configured by connecting a single server device (an authentication center server device) 1 managed and operated by a digital signature surrogation service agent to a plurality of user terminals 2 (of which only one terminal is illustrated in FIG. 1) used respectively by a plurality of users who established a contract about the digital signature surrogation with the digital signature surrogation service agent via a network N in a way that enables them to communicate with each other. Note that, e.g., the Internet is utilizable as this network N, and in this case the communications between the authentication center server device 1 and the respective user terminals 2 are performed based on HTTP (HyperText Transfer Protocol).

The authentication center server device 1 is a computer preinstalled with a network server function and is constructed hardwarewise of a CPU (Central Processing Unit) 10 for controlling the whole device, an interface unit 11, a RAM (Random Access Memory) 12 and a HDD (Hard Disk Drive) 13 which are connected via a bus B to the CPU 10. Among these components, the interface unit 11 is an interface adapter controlled by a program (a device program) stored on the HDD 13 and executed by the CPU 10. This interface adapter serves as an interface with the network N. Further, the RAM 12 is a main memory device on which an operation area used by the CPU 10 is developed.

Moreover, the HDD 13 is defined as a computer readable storage medium serving as a storage device for storing a variety of programs and various categories of data. The variety of programs stored on this HDD 13 include a digital signature surrogation program that will be explained later on referring to a flowchart in addition to OS (Operating System) as a basic program containing the aforementioned device driver and the communication function. The digital signature request program instructs the CPU 10 to generate a digital signature in response to a digital signature surrogation request (containing the signature object content and a unique key ID of the user who uses the user terminal 2) sent from each user terminal 2. Further, the digital signature surrogation program instructs the CPU 10 to authenticate the digital signature in response to a digital signature authentication request (containing the signature object content, a signature value defined as a substance of the digital signature, and the unique key ID of the user who uses the user terminal 2) sent from each user terminal 2. The digital signature surrogation program is constructed of respective modules such as a signature generation module 121, a signature authentication module 122 and a key management module 123, which are read onto the RAM 12. The signature generation module 121 is for generating the digital signature. The signature authentication modulc 122 is for authenticating the digital signature. The key management module 123 is for searching for a secret key or a public key of the user that is invoked and designated by the signature generation module 121 or the signature authentication module 122.

Further, the various categories of data stored on the HDD 13 contain a key storage 131 defined as a table for storing a key pair (a combination of the secret key and the public key) generated beforehand for every user. This key storage 131 has, concretely, a data structure shown in FIG. 2, and is structured by registering, as one record per user, a combination of identifying information (the key ID) and a password (PW) which the user has been previously notified of, and the combination of the secret and public keys.

On the other hand, each of the user terminals 2 is a general type of personal computer having a network access function, and is constructed of a CPU (Central Processing Unit) 20 for controlling the whole device, an interface unit 21, a RAM 22, a HDD 23, a display 24 and an input device 25 which are connected via the bus B to the CPU 20. Among these components, the interface unit 21 is an interface adapter controlled by a program (a device program) stored on the HDD 23 and executed by the CPU 20. This interface adapter serves as an interface with the network N. Further, the RAM 22 is a main memory device on which an operation area used by the CPU 20 is developed. Moreover, the input device 25 is a keyboard, a pointing device, etc. manipulated by a person in charge who belongs to the user, thereby inputting various categories of information to the CPU 20. Further, the display 24 is a display device for displaying various screens generated by the CPU 20.

Moreover, the HDD 23 is defined as a computer readable storage medium for storing a variety of programs and various categories of data. The variety of programs stored on this HDD 23 include an application program for generating a signature object content and a digital signature request program that will be described later on with reference to a flowchart in addition to OS (Operating System) as a basic program containing the aforementioned device driver and the communication function. This digital signature request program instructs the CPU 20 to transmit, to the authentication center server device 1, request for surrogation of signature for the signature object content generated by the application program on the RAM 22 as the storage unit or for the signature object content captured onto the RAM 22. Further, the digital signature request program instructs the CPU 20 to transmit to the authentication center server device 1 a request for authenticating an undersigned content captured onto the RAM 22 through the interface unit 21 or from an unillustrated removable storage medium. The digital signature request program includes respective modules such as an undersigned content forming module 221 and a Digest value calculation module 222 which are read onto the RAM 22. The undersigned content forming module 221 requests the authentication center server device 1 to create a digital signature, attaches signature object electronic information and a key ID to a signature value (the digital signature) responded as a result of requesting to form the undersigned content (electronic information) in an XML (Extensible Markup Language) file format. Further, the undersigned content forming module 221 requests the authentication center server device 1 to authenticate the digital signature and instructs the display 24 to display a result of the authentication responded as a result of requesting. The Digest value calculation module 222 is for calculating a Digest value (Hash value) of the signature object content (XML text) invoked and designated by the content structuring module 221.

The aforementioned process by the digital signature request program on the user terminal 1 and the process by the digital signature surrogation program on the authentication center server device 2, will be explained separately at a time when generating the digital signature and a time when authenticating the digital signature.

To begin with, the processes by the digital signature request program and the digital signature surrogation program executed when generating the digital signature between the user terminal 2 as an issuer of the signature object content and the authentication center server device 1, will be described referring to a flowchart (the digital signature request program) in FIG. 3, a flowchart (the digital signature surrogation program) in FIG. 4 and a sequence diagram in FIG. 5.

Upon an input of a predetermined command by operator's manipulating the input device 25, the digital signature request program shown in FIG. 3 is started up on the user terminal 2. Note that this command contains a path to the signature object content, a key ID and a password as parameters.

In first step S01 after the start, the digital signature request program captures the signature object content which the designated path specifies, together with the key ID and the password designated by the command as the parameters.

In next step S02, the digital signature request program boots the Digest value calculation module 222 and commands this module 222 to calculate a Digest value for the signature object content captured in S01.

In next step S03, the digital signature request program sends, via the interface unit 21 to the authentication center server device 1, a digital signature generation request message containing the key ID and the password captured in S01 and the Digest value calculated by the Digest value calculation module 222. Thereafter, the digital signature request program waits in S04 for a response (i.e., a signature value which will be described later on) to be sent from the authentication center server device 1 in response to the digital signature generation request message sent in S03.

In the authentication center server device 1, upon receiving this digital signature generation request message, the digital signature surrogation program shown in FIG. 4 is started up. In first step S11 after the start, the signature generation module 121 boots and instructs the key management module 123 to search the key storage 131 for a secret key corresponding to a combination of the key ID and the password contained in the digital signature generation request message received from the user terminal 2. The key management module 123, if this secret key exists in the key storage 131, responds this secret key to the signature generation module 121. Whereas if this secret key does not exist (including a case where there is no mapping between the key ID and the password), however, sends an error message to the requester user terminal 2.

The signature generation module 121 having received the secret key, in next step S12, encrypts the Digest value contained in the digital signature generation request message reccived from the key management module 123 by use of the secret key received from the key management module 123, thereby generating the signature value defined as a substance of the digital signature.

In next step S13, the signature generation module 121 sends the signature value generated in S12 to the requester user terminal 2 via the interface unit 11.

In the requester user terminal 2, the digital signature request program, upon receiving the signature value from the authentication center server device 1, advances the processing to S05 from S04.

In S05, the digital signature request program boots the undersigned content forming module 221, whereby the undersigned content forming module 221 forms an undersigned content by attaching the signature object content captured in S01 with the key ID captured similarly in S01 and the signature value received from the authentication center server device 1 in S04 and storing the undersigned content in an XML file. Thus structured undersigned content is encrypted as the necessity may arise and is sent to a recipient party via the network N in a state of being stored in an electronic mail or in a state of being stored on a removable medium.

Next, the processes by the digital signature request program and the digital signature surrogation program executed when authenticating the digital signature between the user terminal 2 as the content recipient and the authentication center server device 1, will be explained referring to a flowchart (the digital signature request program) in FIG. 6, a flowchart (the digital signature surrogation program) in FIG. 7 and a sequence diagram in FIG. 8.

Upon an input of a predetermined command by operator's manipulating the input device 25, the digital signature request program shown in FIG. 6 is started up on the user terminal 2. Note that this command contains a path to the undersigned content as a parameter.

In first step S21 after the start, the digital signature request program captures the undersigned content specified by the path designated as the parameter.

In next step S22, the digital signature request program boots the undersigned content forming module 221, and extracts a signature object content, a signature value and a key ID respectively from the undersigned content captured in S21.

In next step S23, the digital signature request program boots the Digest value calculation module 222 and commands this module 222 to calculate a Digest value for the signature object content extracted in S22.

In next step S24, the digital signature request program sends, via the interface unit 21 to the authentication center server device 1, a digital signature authentication request message containing the key ID and the signature value extracted in S22 and the Digest value calculated by the Digest value calculation module 222. Thereafter, the digital signature request program waits in S25 for a response (i.e., an authentication result which will be explained later on) to be sent from the authentication center server device 1 in response to the digital signature authentication request message sent in S24.

In the authentication center server device 1, upon receiving this digital signature authentication request message, the digital signature surrogation program shown in FIG. 7 is started up. In first step S31 after the start, the signature authentication module 122 boots and instructs the key management module 123 to search the key storage 131 for a public key corresponding to the key ID contained in the digital signature authentication request message received from the user terminal 2. The key management module 123, if this public key exists in the key storage case 131, responds this public key to the signature authentication module 122. Whereas if this public key does not exist, however, sends an error message to the requester user terminal 2.

The signature authentication module 122 having received the public key, in next step S32, decrypts the signature value contained in the digital signature authentication request message received from the user terminal 2 by use of the public key received from the key management module 123.

In next step S33, the signature authentication module 122 checks whether or not a substance of the signature value decrypted in S32 is coincident with the Digest value contained in the digital signature authentication request message received from the user terminal 2.

Then, if both of them are coincident with each other, it is obvious that the signature object content based on which the Digest value is calculated is the content itself of which the digital signature is requested by the issuer, namely the content based on which the Digest value encrypted with the secret key of the issuer is calculated. Hence, the signature authentication module 122 sends “OK” as a signature authentication result to the requester user terminal 2 via the interface unit 11 in S34.

Whereas if both of them are not coincident, it is not assured that the signature object content based on which the Digest value is calculated is the content itself of which the digital signature is requested by the issuer, namely, the content based on which the Digest value encrypted with the secret key of the issuer is calculated. That implies a possibility that the Digest value has been encrypted with the secret key of the issuer, however, these contents are originally different from each other, or that the Digest value of this content might have been encrypted with a secret key of a party other than the issuer. Hence, the signature authentication module 122 sends “NG” as a signature authentication result to the requester user terminal 2 via the interface unit 11 in S35.

In the requester user terminal 2, the digital signature request program, upon receiving any one of the signature authentication results from the authentication center server device 1, advances the processing to S26 from S25, and displays this signature authentication result on the display 24.

As discussed above, the digital signature system in the present embodiment adopts the system in which the each of the user terminals 2 requests the authentication center server device 1 to surrogate for generating and authenticating the digital signature via the network N, and nevertheless the information actually encrypted as the signature value with the secret key in the authentication center server device 1 (which is therefore the information decrypted from the signature value with the public key of the user in the authentication center server device 1) is not the signature object content itself but merely the Digest value (Hash value) calculated from this signature object content. This Digest value is uniquely generated from one content, however, the substance of the original content can not be reproduced based on this Digest value. Accordingly, the authentication center server device 1 having received this Digest value and having also decrypted the Digest value is unable to know the substance of the signature object content but is capable of indirectly making the authentication as to whether the signature object content of which the digital signature generation is requested by the issuer is identical with or different from the signature object content of which the digital signature authentication is requested by the recipient party.

The present invention having the architecture described above enables the server device on the network to surrogate for generating or authenticating the digital signature, thereby making it possible to reduce a load on the user and at the same time to generate the signature value functioning as the digital signature without encrypting or decrypting the signature object electronic information itself on the server device. Hence, there is no possibility in which the substance of the signature object electronic information is known by an administrator of the server device.

We claim:

1. A digital signature generation method for generating a digital signature for electronic information existing on a storage unit of a terminal in a system configured to enable said terminal and a server device to communicate with each other via a network, said method comprising steps of:
calculating, in said terminal, a Digest value for the electronic information;
sending, from said terminal to said server device, the Digest value and identifying information of a user as an issuer of the electronic information;
taking, in said server device, a secret key corresponding to the identifying information received from said terminal, out of a storage device stored with a pair of a secret key and a public key related with identifying information of each user;
generating, in said server device, a signature value by encrypting the Digest value received from said terminal with the secret key taken out of said storage device;
responding, from said server device to said terminal, the generated signature value; and
forming, in said terminal, undersigned electronic information by attaching the signature value and the identifying information responded from said server device to the electronic information.

2. A digital signature authentication method for authentication undersigned electronic information obtained by said digital signature generation method according to claim 1, in a system configured to enable said terminal and a server device to communicate with each other via a network, said method comprising steps of:
calculating, in said terminal, a Digest value for electronic information in the undersigned electronic information;
sending, from said terminal to said server device, the Digest value, and a signature value and the identifying information in the undersigned electronic information;
taking, in said server device, a public key corresponding to the identifying information received from said terminal, out of said storage device;
decrypting, in said server device, the signature value received from said terminal with the public key taken out of said storage device;
comparing, in said server device, a substance of the decrypted signature value with the Digest value received from said terminal; and
responding, by said server device, a result of the comparison to said terminal.

3. A digital signature generation request program for a computer communicable via a network with a server device including a storage device stored with a pair of a secret key and a public key related with identifying information of each user, said computer taking, when receiving a digital signature generation request message designating encryption object information and identifying information, the secret key corresponding to the received identifying information out of said storage device, generating a signature value by encrypting the encryption object information with the secret key and responding the generated signature value, said program making said computer:
(a) if electronic information and identifying information of a user as an issuer of the electronic information are specified,
calculate a Digest value for the electronic information; and
send the digital signature generation request message containing the calculated Digest value as the encryption object information and the identifying information to said server device; and
(b) if the signature value is responded from said server device,
form undersigned electronic information by attaching the signature value and the identifying information to the electronic information.

4. A digital signature authentication request program for a computer communicable via a network with a server device including a storage device for stored with a pair of a secret key and a public key related with identifying information of each user, said computer taking, when receiving a digital signature authentication request message designating authentication object information, signature value and identifying information, the public key corresponding to the received identifying information out of said storage device, decrypting the signature value width the public key, comparing the decrypted signature value with the authentication object information, and responding a result of the comparison, said program making said computer:
if undersigned electronic information obtained according to claim 1 or 3 is inputted,
calculate a Digest value for the electronic information in the undersigned electronic information; and
send the digital signature authentication request message containing the Digest value as the authentication object information and the signature value and the identifying information in the undersigned electronic information to said server device.
